(19) United States
(12) Patent Application Publication
(10) Pub. No.: US 2014/0379260 A1
(43) Pub. Date: Dec. 25, 2014

(54) Vehicle Display Device with Vehicle Movement Compensation

(71) Applicant: Daimler AG, Stuttgart (DE)

(72) Inventor: Christian Maihoefer, Iggingen (DE)

(21) Appl. No.: 14/376,260

(22) PCT Filed: Dec. 12, 2012
(86) PCT No.: PCT/EP2012/005131

§ 371 Date: Aug. 1, 2014

(30) Foreign Application Priority Data
Feb. 2, 2012 (DE) 10 2012 001 951.3

(51) Int. Cl. G01C 21/36; B60W 50/14; G02B 27/01

(52) U.S. Cl. CPC G01C 21/365; G02B 27/01; B60W 50/14; B60W 2050/146
USPC 701/538

(57) ABSTRACT

A display device for a vehicle includes an imager that depicts at least one piece of image information on a surface arranged in a vehicle. Depending on an independent movement of the vehicle, the at least one piece of image information can be changed by a compensation device that is designed for the at least substantial compensation for the independent movement of the vehicle. The compensation device is coupled to a determination device, by means of which at least one condition present in the environment of the vehicle can be determined, with which the independent movement of the vehicle can be brought about. The compensation device is configured to convert the at least one piece of image information to a signal of the determination device.

### CROSS-REFERENCE TO RELATED APPLICATIONS

The present application is related to PCT International Application PCT/EP2012/005132, filed Dec. 12, 2012, a U.S. national stage of which is U.S. Ser. No. ______ (Attorney Docket No. 095309.66826US).

### BACKGROUND AND SUMMARY OF THE INVENTION

Exemplary embodiments of the invention relate to a display device for a vehicle, which comprises an imager, wherein the imager is designed to depict at least one piece of image information on a surface arranged in a vehicle. The display device furthermore comprises a compensation device, by means of which, depending on an independent movement of the vehicle, the at least one piece of image information can be changed and thus the independent movement of the vehicle can be at least substantially compensated for. Exemplary embodiments of the invention also relate to a method for the operation of such a display device.

German patent document DE 10 2009 045 169 A1 describes a display device for a vehicle, having an imager for generating an image and having imaging optics for projecting the image onto a windscreen of the vehicle. A camera records a head position or a viewing direction of a driver. During the recording of a head movement or a change in the viewing direction of the driver, the position of image objects, such as directional arrows, are changed by means of an evaluation device in such a way that the image objects appear as contact analogue to real objects in the field of vision of the driver. If the vehicle undergoes a pitching movement, the windscreen therefore moves with it. When such an independent movement of the windscreen, so the projection surface, is detected, a compensation device changes the position of the image objects in such a way that the independent movement of the vehicle is compensated for.

Head-up displays, by means of which graphical information for the navigation of a vehicle is depicted, are also known from the prior art.

Image information that is depicted on a surface such as the windscreen of a vehicle or on a screen or display is commonly referred to as augmented reality. Images or videos are hereby augmented with additional, computer-generated information as an overlay or superimposition.

In applications of augmented reality that are known from prior art, which are used in particular for navigational support, the overlaying of information takes place at the correct point of the surface comparatively precisely and well. However, independent movements of the surface have so far been insufficiently compensated for. Thus, a piece of image information, such as a directional arrow, does not appear to remain static in one position, but rather it jumps around. This has a considerable negative effect on the usability of augmented reality.

Exemplary embodiments of the present invention are directed to a display device of the type specified above, as well as a method, which enable as substantial level of compensation as possible for the independent movement in a particularly simple manner.

In the display device according to the invention, the compensation device is coupled to a determination device, by means of which at least one condition present in the environment of the vehicle can be determined, wherein the independent movement of the vehicle can be brought about by the condition. The compensation device is configured to convert the at least one piece of image information to a signal of the determination device. The determination device thus enables, in the manner of a route forecast, the consideration of conditions in the environment of the vehicle that are to anticipate the movement of the vehicle if the vehicle reaches the condition.

Such conditions can be bumps in the ground or pot holes or, for example, stop lines, at which a braking movement of the vehicle as an independent movement typically effects a pitching motion. If, for example, unevenness in the road is detected by sensors of the vehicle, an effective reaction in the form of changing the image information is, in reality, hardly possible. However, the determination device enables, for example, the road condition to be detected before the vehicle reaches a point at which the independent movement of the vehicle is likely to be engaged. Then, with the change in image information and thus the compensation for the independent movement, there is a reaction to this in good time.

The amended or corrected image information is thus depicted on the surface without this depiction being negatively influenced by the independent movement of the vehicle. An undesired movement such as a skipping of the image information is thus prevented simply and safely. Thus, in a particularly simple manner, a particularly substantial compensation for the independent movement of the vehicle can be achieved. Due to the fact that the image information can be allocated clearly according to its purpose, the image information can be used particularly easily by a user of the display device, so by an observer of the surface. This renders the operation of the display device particularly comfortable, simple and valuable.

Particularly if the pieces of image information, as elements, that provide augmented reality are used for navigational support, this simplifies the operation of the vehicle. Also, operating errors during the operation of the vehicle can thus be prevented particularly well.

In an advantageous embodiment of the invention, the determination device is formed as a detector, by means of which the at least one condition can be determined by image analysis. For example, the detector can record the road condition as an image or can record the presence of stop signs or red traffic lights, at which it is to be expected that the vehicle will stop. Such a detector enables a particularly reliable route forecast. This also applies if the detector is additionally or alternatively designed to determine the at least one condition in the environment of the vehicle by evaluating waves emitted by the vehicle. Here, radar systems, laser systems or devices can be used, which are operated by electromagnetic waves from the infrared range, or the use of ultrasound sensors can be provided.

Particularly if the direct detectability of the environment of the vehicle is made more difficult, it has been shown to be advantageous if the determination device is designed as a receiver, by means of which information transmitted by a further vehicle relating to the at least one condition can be recorded. With such vehicle-to-vehicle communication, a vehicle driving in front, which, for example, drives over a bump and thus carries out an independent movement, can communicate the presence of this bump to the subsequent vehicle or to a vehicle coming in the other direction. Thus, in a simple manner, the vehicle having the display device can take into consideration the presence of the bump before it reaches it.

The determination device can also be designed as an interrogative device, by means of which a database, in which data values specifying the at least one condition are stored, can be interrogated. Such a database can exist in the form of a generally accessible data infrastructure cloud, in which the conditions are available in the form of highly-accurate entries in the database. Such a database also offers the advantage that it can be used independently of whether the condition has already been found in an actual detection region of a detector. Such a database can be present outside the vehicle or in the vehicle.

Particularly in the latter case, the data values can be stored in the database depending on an independent movement of the vehicle, which is caused by the at least one condition. For example, a control device of the vehicle can store a data value, which specifies a bump in the ground, in the vehicle database, if the vehicle carries out the independent movement for the first time when driving over the bump. Then, when the same bump in the ground is arrived at again, the image information can be changed in good time and thus the independent movement of the vehicle can be compensated for. This has the advantage that the size of the database can be monitored and thus can remain easy to use. In addition, frequently occurring independent movements of the vehicle, for example on routes that are covered regularly, can be taken into account particularly well. The independent movement of the vehicle, which leads to the data value being stored in the vehicle database, can herein have been detected in particular by means of a sensor of the vehicle.

The surface arranged in the vehicle can be designed as a windscreen of the vehicle. Here, the at least one piece of image information can be projected from the imager onto the screen as a projection surface. In such a representation of the image information, this is therefore overlaid into the real environment by means of a head-up display. If the independent movement of the vehicle is compensated for when the condition has been reached, pitching movements or swaying movements of the vehicle do not lead to effects on the representation of the image information that are disruptive for the observer

However, the surface can also be designed as a display or screen on which an image recorded by a camera is depicted and superimposed by the image information. Here, the display also moves with the vehicle if this undergoes a movement around its transverse axis or longitudinal axis; the pitching and/or swaying of the vehicle is therefore compensated for.

The compensation device can be configured to displace the at least one piece of image information in a vertical direction and/or in a transverse direction of the surface in order to compensate for the independent movement of the vehicle. This enables pitching movements and/or yawing of the vehicle to be compensated for particularly well.

If, to compensate for the independent movement of the vehicle, the image information is enlarged and/or decreased at least in certain regions, a reduction in the perceptibility of a movement of the image information is achieved in a particularly simple manner.

By rotating the image information, swaying movements of the vehicle can be compensated for particularly well, which occur when the vehicle reaches the condition. The compensation device can, however, also be configured to hide the image information to compensate for the independent movement of the vehicle. Then, a piece of information being delivered that could potentially be misinterpreted or clearly difficult to assign is safely prevented by depicting the image information to a vehicle user.

The image information can particularly be formed as elements that simplify the navigation of the vehicle. Then, in a particularly evident manner, the image information supports a vehicle driver during the operation of the vehicle. For example, an arrow may indicate that a vehicle is to turn off at a specific point of the surrounding area. If such an arrow, due to the independent movement of the vehicle, also moves, the independent movement of the vehicle is therefore not compensated for; this can render the clear allocation of the arrow to the actual point of turn-off more difficult. This can lead to the vehicle driver slowing down and holding up traffic, or the vehicle driver turning off at the wrong point. This is prevented by the display device described in the present case.

The image information that simplifies the navigation of the vehicle can, however, also be designed as a line, for example as a driving line or carriageway delineation and thus can simplify the safe navigation of the vehicle.

In a further advantageous embodiment of the invention, the compensation device is configured to change the at least one piece of image information depending on a signal of the determination device, which specifies a geographical position of the at least one condition. Then, as desired, the image information can be changed with particular precision when the condition has been reached by the vehicle.

The compensation device can, however, also be configured to change the at least one piece of image information depending on a signal of the determination device, which specifies an expected time span up to when the vehicle will reach the at least one condition. This can then be implemented particularly simply if a reasonably constant driving speed of the vehicle is present. In addition, such a time-controlled change of the image information can be implemented technically with particularly little effort.

Finally, it has been shown to be advantageous if the compensation device is configured, when changing the at least one piece of image information, to take into consideration a change in perspective caused by the independent movement of the vehicle, under which conditions a vehicle driver observes the surface. There then arises no undesired distortion of the image information for the vehicle user or observer, the distortion being able to be effected by a very strong independent movement of the vehicle, for example. When a piece of image information is only corrected with respect to its position, a strong pitching movement of the vehicle now leads to this potentially being observed more from above or more from below, if this distortion is also not compensated for as is described in the present instance.

In the method according to the invention for the operation of a display device for a vehicle, at least one piece of image information is depicted on a surface arranged in a vehicle by means of an imager. Depending on an independent movement of the vehicle, the at least one piece of image information is changed by means of a compensation device that is designed for the at least substantial compensation for the independent movement of the vehicle. Here, a determination device determines at least one condition present in the environment of the vehicle, with which the independent movement of the vehicle can be brought about. A signal is transmitted from the determination device to the compensation device, and the compensation device converts the at least one piece of image information to the signal of the determination device when the vehicle reaches the at least one condition. There can thus be a timely reaction to the condition present in the environment of the vehicle, and the image information can be depicted at a fixed point on the surface relative to the moving vehicle.

The advantages and preferred embodiments described for the display device according to the invention are also valid for the method according to the invention.

The features and feature combinations cited in the description above and the features and feature combinations cited below in the description of the figures and/or shown in the figures alone can be used not only in each specified combination, but rather also in other combinations or individually, without exceeding the scope of the invention.

### BRIEF DESCRIPTION OF THE DRAWING FIGURES

Further advantages, features and details of the invention arise from the claims, the description of preferred embodiments below and with the aid of the figures. Here are shown:

FIG. 1 a turn-off arrow overlaid into a real environment of a vehicle by means of a head-up display; and

FIG. 2 schematically, a process in which, when overlaying image information into the environment of the vehicle, the position and the distortion of the turn-off arrow or such a piece of image information are corrected depending on information gleaned over a route forecast.

### DETAILED DESCRIPTION

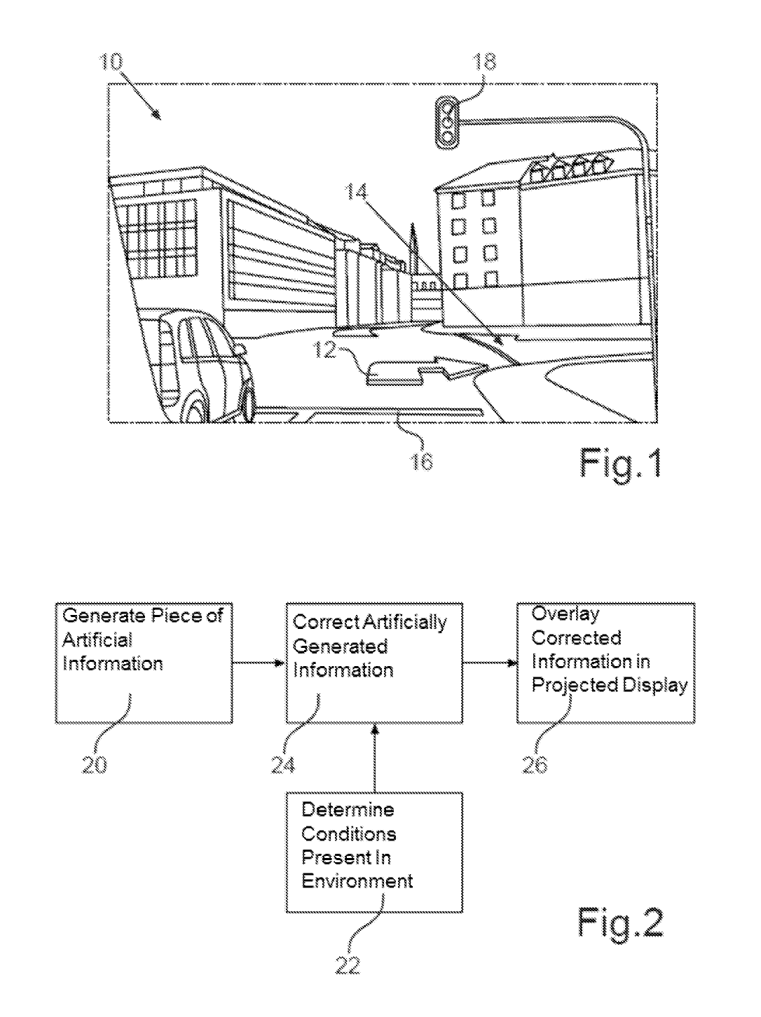

FIG. 1 shows a vehicle environment 10 as exists through a windscreen of a vehicle in the line of vision of a driver (not shown) of the vehicle. As an example of artificially generated image information, a turn-off arrow 12 is overlaid into the vehicle environment 10. This occurs by an imager of a head-up display or similar display device of the vehicle projecting the turn-off arrow 12 onto the windscreen of the vehicle. The turn-off arrow 12 specifies that a crossing 14 is to be turned off at, and it is shown by way of example for image information that simplifies the navigation of the vehicle. Such image information, which is projected, for example, by means of overlaying into the vehicle environment 10, is also known as augmented reality.

It can now occur that the vehicle undergoes a pitching movement due to a braking process, so a rotational movement around a transverse axis of the vehicle. If, in such a case, the turn-off arrow 12 is left at the same position as in the image section of the projection surface shown in FIG. 1, it would then move with the projection surface. The turn-off arrow 12 would then no longer be located at the position of the crossing 14 and the driver would have difficulties in unambiguously allocating the turn-off arrow 12 to the desired turn-off point.

In order to prevent such a skipping of the turn-off arrow 12, a determination device is presently used, which provides information regarding independent movements of the vehicle that are to be expected over a route forecast.

For example, the braking of the vehicle at a stop line 16 in front of a red traffic light 18 in the vehicle environment 10 can lead to the vehicle undergoing a pitching movement when the stop line 16 is reached. In the present case, the determination device now detects the presence of the stop line 16 and/or the red traffic light 18 before the vehicle actually reaches the stop line 16. There can thus be a timely reaction to the pitching movement of the vehicle that is engaged when the stop line 16 is reached, and compensation for the pitching movement is in fact possible.

Due to this compensation, which is carried out by means of a compensation device of the display device depending on a signal of the determination device, the turn-off arrow 12 is always overlaid at the position of the crossing 14. Its absolute position with respect to the vehicle environment 10 thus remains unchanged, even if the vehicle moves and the windscreen onto which the turn-off arrow 12 is projected moves with it. This leads to the turn-off arrow 12 being clearly allocated to the turn-off point, namely the crossing 14. In addition, the augmented reality in the form of the turn-off arrow 12 is maintained particularly well, despite the pitching of the vehicle.

The presence of the stop line 16 in the vehicle environment 10 can be determined by the determination device in various ways. For example, a camera can detect the vehicle environment 10 and the stop line 16 and the traffic lights 18 with the aid of image analysis. Furthermore, the use of a laser system or similar detector using electromagnetic waves has turned out to be expedient, particularly for the determination of bumps or potholes.

The presence of, for example, bumps, can, however, also be transmitted by vehicle-to-vehicle communication to the vehicle having the head-up display. In this case, the determination device is designed as a receiver, which is able to detect the information emitted from another vehicle regarding the bump or similar condition in the vehicle environment 10.

It is also possible to determine the presence of conditions in the vehicle environment 10 by carrying out a database interrogation, the conditions bringing about a pitching movement, a yawing or a swaying movement of the vehicle when these conditions have been reached. Such a database can, as a generally accessible, highly-accurate database, contain data values that specify the geographical position of the conditions. The database can additionally or alternatively be present locally in the vehicle. Then, corresponding entries can, for example, be stored in such a database as soon as the vehicle drives over a bump or pot hole at a specific geographical position or comes to a stop at a stop line 16 and this leads to an independent movement of the vehicle. Thus, the vehicle constructs a highly accurate database that is increasingly suitable for roads that are covered by the vehicle.

FIG. 2 illustrates a method to compensate for an independent movement of the vehicle, for example the pitching when the stop line 16 is reached. Initially, a piece of artificial information is generated (step 20), for example the turn-off arrow 12, which is to be superimposed over the real image—in the present case the vehicle environment 10 that can be seen by the driver.

Next, the determination device determines the conditions present in the vehicle environment 10, which may lead to the independent movement of the vehicle when these conditions have been reached (step 22). After this, before the respective condition has been reached, so, in the exemplary embodiment, before the stop line 16 has been reached, the artificially generated image information is corrected in a timely manner (step 24). The position of the turn-off arrow 12 is hereby corrected in such a way that, despite the pitching movement of the vehicle, it remains at the position of the crossing 14. In addition, the distortion of the turn-off arrow 12 can also be compensated for during the correction 24, if this is now observed more from above or more from below as a result of the pitching movement.

The corrected, therefore amended artificial information, in the present case the turn-off arrow 12, is projected onto the windscreen of the vehicle by a overlaying this into the vehicle environment 10 at the desired correct position (step 26).

In the present case, the route forecast is used in order to calculate the pitching movement of the vehicle in advance and thus to correct the artificially generated image information according to the conditions present in the vehicle environment 10. When using the display device formed as a head-up display, the position of the artificial image information in the form of the turn-off arrow 12 is adapted accordingly to arising pitching movements of the vehicle, in order to guarantee an exact superimposition of the projection with the real image. Due to the fact that a clear allocation of the turn-off arrow to the crossing 14 is provided for the observer, the operation of the vehicle is simplified, since, for example, a false turn-off of the vehicle can be prevented.

If the depiction does not take place by means of a head-up display, but rather the turn-off arrow 12 is to be reproduced on a display, for example the central display of the vehicle, then the artificially generated, corrected image information, so presently the turn-off arrow 12, is mixed with the real image depicted on the display.

The display device can, in particular, be used in the field of vehicle applications comprising, for example, navigation, telephone, audio and video sources, as well as communication connection thereof and the use thereof for other vehicle applications.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A display device for a vehicle, comprising:
an imager configured to depict at least one piece of image information on a surface arranged in the vehicle;
a compensation device configured to at least substantially compensate for an independent movement of the vehicle by changing the at least one piece of image information depending on the independent movement of the vehicle; and
a determination device, coupled to the compensation device, that is configured to detect at least one condition present in the environment of the vehicle, with which the independent movement of the vehicle can be brought about, wherein the compensation device is configured to convert the at least one piece of image information into a signal of the determination device.

12. The display device of claim 11, wherein the determination device is a detector configured to detect the at least one condition by image analysis or by evaluating electromagnetic waves emitted by the vehicle.

13. The display device of claim 11, wherein the determination device is a receiver configured to detect information emitted by a further vehicle relating to the at least one condition.

14. The display device of claim 11, wherein the determination device is an interrogative device configured to interrogate a database storing data values specifying the at least one condition.

15. The display device of claim 14, wherein the data values are stored in the database depending on an independent movement of the vehicle caused by the at least one condition, wherein the independent movement is detected by a sensor of the vehicle.

16. The display device of claim 11, wherein the surface arranged in the vehicle is a windscreen of the vehicle or a display of the vehicle.

17. The display device of claim 11, wherein in order to compensate for the independent movement of the vehicle, the compensation device is configured
to displace the at least one piece of image information, which is an element that simplifies navigation of the vehicle, in a vertical direction or in a transverse direction of the surface,
to enlarge or reduce the image information, at least in regions, or
to rotate or conceal the image information.

18. The display device of claim 11, wherein the compensation device is configured to change the at least one piece of image information depending on a signal of the determination device, which specifies a geographical position of the at least one condition or an expected time span up to which the at least one condition is reached by the vehicle.

19. The display device of claim 11, wherein the compensation device is configured, when changing the at least one piece of image information, to take into consideration a change in perspective caused by the independent movement of the vehicle, under which conditions a vehicle driver observes the surface.

20. A method for the operation of a display device for a vehicle, the method comprising:
depicting, by an imager, at least one piece of image information on a surface arranged in a vehicle;
at least partially compensating, by a compensation device, for an independent movement of the vehicle changes the at least one piece of image information depending on the independent movement of the vehicle; and
determining, by a determination device, at least one condition present in the environment of the vehicle, with which the independent movement of the vehicle can be brought about,
wherein when the vehicle reaches the at least one condition the determination device transmits a signal to the compensation device and the compensation device converts the at least one piece of image information.
